(19) United States
(12) Patent Application Publication
(10) Pub. No.: US 2011/0068620 A1
(43) Pub. Date: Mar. 24, 2011

(54) WEAR PROTECTORS FOR PROTECTING GUIDE AND/OR DRIVE LUGS OF AN ENDLESS TRACK FOR TRACTION OF AN OFF-ROAD VEHICLE

(76) Inventors: Marc Delisle, Magog (CA); Martin Denis, Magog (CA)

(21) Appl. No.: 12/562,641

(22) Filed: Sep. 18, 2009

(51) Int. Cl. B62D 55/24

(52) U.S. Cl. 305/165; 305/194

(57) ABSTRACT

Wear protectors for protecting guide and/or drive lugs of an endless track for traction of an off-road vehicle. Each wear protector comprises a cover shaped to cover at least part of a periphery of a lug. A fastener may be used to fasten the cover to the lug. The cover may comprise an aperture for admitting the fastener such that the fastener extends inside the lug and is capable of being put in a state of tension, allowing elastomeric material of the lug to be in a state of compression. The cover may comprise a pair of covering members separate from one another and respectively covering at least part of opposite surfaces of the lug. The fastener may extend through the lug and interconnect the covering members.

### FIELD OF THE INVENTION

The invention relates to endless elastomeric tracks for traction of vehicles operable in off-road conditions.

### BACKGROUND

Certain off-road vehicles, such as construction vehicles (e.g., loaders, bulldozers, excavators, etc.), agricultural vehicles (e.g., harvesters, combines, tractors, etc.) forestry vehicles (e.g., feller-bunchers, tree chippers, knuckleboom loaders, etc.) and military vehicles (e.g., combat engineering vehicles (CEVs), etc.) to name a few, are often equipped with endless elastomeric tracks that enhance their traction and floatation on soft, low friction and/or uneven grounds (e.g., soil, mud, sand, ice, snow, etc.) on which they operate.

One type of endless elastomeric track comprises an inner side including a plurality of projections, commonly referred to as “lugs”, which are spaced apart in its longitudinal direction and used for guiding and/or driving the track around wheels of a vehicle to which the track provides traction. Very often, a main factor reducing the track's useful life is wear of the lugs due to their motion relative to the wheels of the vehicle. For instance, as they move relative to the wheels of the vehicle, the lugs can come into contact with (e.g., rub or otherwise frictionally contact) one or more of these wheels and this contact can wear out their elastomeric material (e.g., rubber). This contact can be particularly strong when the vehicle is turning or moving on a hill or other sloped terrain. Over time, such contact wears out the elastomeric material of the lugs, possibly to a point where the lugs are so degraded that the track can no longer be used efficiently and has to be repaired or replaced. In some cases, such degradation of the lugs can occur although a carcass of the track remains in acceptable condition. In other words, the lugs can wear out at a significantly greater rate than the carcass of the track.

For these and other reasons, there is a need to improve endless elastomeric tracks for traction of off-road vehicles.

### SUMMARY OF THE INVENTION

According to a first broad aspect, the invention provides a cover for protecting a lug of an inner side of an endless track for traction of an off-road vehicle. The lug comprises elastomeric material and is used for at least one of guiding the endless track and driving the endless track. The cover is shaped to cover at least part of a periphery of the lug. The cover comprises an aperture for admitting a fastener to fasten the cover to the lug such that the fastener extends inside the lug and is capable of being put in a state of tension.

According to a second broad aspect, the invention provides an endless track for traction of an off-road vehicle. The endless track comprises a ground-engaging outer side for engaging the ground and an inner side for facing a plurality of wheels of the off-road vehicle. The inner side comprises a plurality of lugs for at least one of guiding the endless track and driving the endless track. Each lug comprises: elastomeric material; a periphery on which is placeable a cover for protecting the lug; and a cavity for admitting a fastener to fasten the cover to the lug.

According to a third broad aspect, the invention provides a cover for protecting a lug of an inner side of an endless track for traction of an off-road vehicle. The lug comprises elastomeric material, a periphery, and a cavity extending inwardly from the periphery. The cover is shaped to cover at least part of the periphery of the lug and comprises: a protrusion positionable within the cavity to retain the cover on the lug; and an aperture for admitting a fastener to fasten the cover to the lug.

According to a fourth broad aspect, the invention provides an endless track for traction of an off-road vehicle. The endless track comprises a ground-engaging outer side for engaging the ground and an inner side for facing a plurality of wheels of the off-road vehicle. The inner side comprises a plurality of lugs for at least one of guiding the endless track and driving the endless track. Each lug comprises: elastomeric material; a periphery on which is placeable a cover for protecting the lug, the cover comprising a protrusion; and a cavity for receiving the protrusion and admitting a fastener to fasten the cover to the lug.

According to a fifth broad aspect, the invention provides a cover for protecting a lug of an inner side of an endless track for traction of an off-road vehicle. The lug comprises elastomeric material, a periphery, and a cavity extending inwardly from the periphery. The cover is shaped to cover at least part of the periphery of the lug. The cover comprises a protrusion positionable within the cavity to retain the cover on the lug. The protrusion is configured to restrain movement of the cover relative to the lug in two or more directions.

According to a sixth broad aspect, the invention provides an endless track for traction of an off-road vehicle. The endless track comprises a ground-engaging outer side for engaging the ground and an inner side for facing a plurality of wheels of the off-road vehicle. The inner side comprises a plurality of lugs for at least one of guiding the endless track and driving the endless track. Each lug comprises: elastomeric material; a periphery on which is placeable a cover for protecting the lug, the cover comprising a protrusion; and a cavity for receiving the protrusion, the protrusion restraining movement of the cover relative to the lug in two or more directions when the protrusion is in the cavity.

According to a seventh broad aspect, the invention provides a cover for protecting a lug of an inner side of an endless track for traction of an off-road vehicle. The lug comprises elastomeric material, a periphery, and a cavity extending inwardly from the periphery. The periphery of the lug comprises a first surface and a second surface opposite the first surface. The cover comprises: a first covering member for covering at least part of the first surface of the lug; and a second covering member, separate from the first covering member, for covering at least part of the second surface of the lug.

According to an eighth broad aspect, the invention provides an endless track for traction of an off-road vehicle. The endless track comprises a ground-engaging outer side for engaging the ground and an inner side for facing a plurality of wheels of the off-road vehicle. The inner side comprises a plurality of lugs for at least one of guiding the endless track and driving the endless track. Each lug comprises: elastomeric material; a periphery comprising a first surface and a second surface opposite the first surface, at least part of the first surface being coverable by a first covering member, at least part of the second surface being coverable by a second covering member separate from the first covering member; and a cavity extending from the first surface to the second surface for admitting a fastener interconnecting the first covering member and the second covering member.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1 shows an example of an off-road vehicle in accordance with an embodiment of the invention;

FIGS. 2 to 4 respectively show a top view, a side elevation view, and a bottom view of part of an endless track of the off-road vehicle, wherein lugs of the endless track are protected by wear protectors;

FIG. 5 shows a cross-sectional view of the endless track, without the wear protectors;

FIGS. 6A and 6B respectively show a perspective view and a cross-sectional view of one of the lugs of the endless track;

FIG. 7 shows a cross-sectional view of one of the lugs with its wear protector;

FIGS. 8 to 10 respectively show a perspective view, a side elevation view, and a rear view of a covering portion of one of the wear protectors; and

FIG. 11 shows the endless track in relation to a drive wheel of the off-road vehicle.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

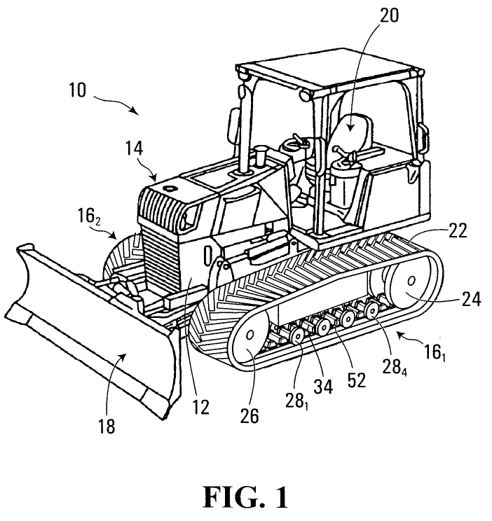

FIG. 1 shows an off-road vehicle 10 in accordance with an embodiment of the invention. In this embodiment, the off-road vehicle 10 is a construction vehicle for performing construction work. More specifically, in this example, the construction vehicle 10 is a bulldozer. In other examples, the construction vehicle 10 may be a backhoe loader, a skid steer loader, an excavator, or any other type of construction vehicle.

The construction vehicle 10 comprises a frame 12 supporting a prime mover 14, a pair of track assemblies 16₁, 16₂, a working implement 18, and an operator cabin 20, which enable an operator to move the construction vehicle 10 on the ground to perform construction work.

The prime mover 14 provides motive power to move the construction vehicle 10. For example, the prime mover 14 may comprise an internal combustion engine and/or one or more other types of motors (e.g., electric motors, etc.) for generating motive power to move the construction vehicle 10. The prime mover 14 is in a driving relationship with each of the track assemblies 16₁, 16₂. That is, power derived from the primer mover 14 is transmitted to each of the track assemblies 16₁, 16₂ via a power train of the construction vehicle 10.

The working implement 18 is used to perform construction work. In this embodiment, the working implement 18 is a dozer blade that can be used to push objects and shove soil, debris or other material. In other embodiments, the working implement 18 may take on various other forms, such as a bucket, a backhoe, a fork, a grapple, a scraper pan, an auger, a saw, a ripper, a material handling arm, or any other type of construction working implement.

The operator cabin 20 is where the operator sits and controls the construction vehicle 10. More particularly, the operator cabin 20 comprises a set of controls that allow the operator to steer the construction vehicle 10 on the ground and operate the working implement 18.

The track assemblies 16₁, 16₂ are drivable by the prime mover 14 to propel the construction vehicle 10 on the ground. More particularly, in this embodiment, each track assembly 16ᵢ (i=1 or 2) comprises an endless track 22 disposed around a plurality of wheels, including a drive wheel 24, an idler wheel 26, and a plurality of roller wheels 28₁-28_{R}.

The drive wheel 24 is rotatable by power produced by the prime mover 14 for driving the endless track 22 to propel the construction vehicle 10 on the ground. The idler wheel 26 and the roller wheels 28₁-28_{R} do not convert power supplied by the prime mover 14 to motive force, but rather guide the endless track 22 and/or maintain it under tension as it is driven by the drive wheel 24. As the endless track 22 is driven by the drive wheel 24, the roller wheels 28₁-28_{R} roll on a lower run of the endless track 22 to apply it on the ground for traction.

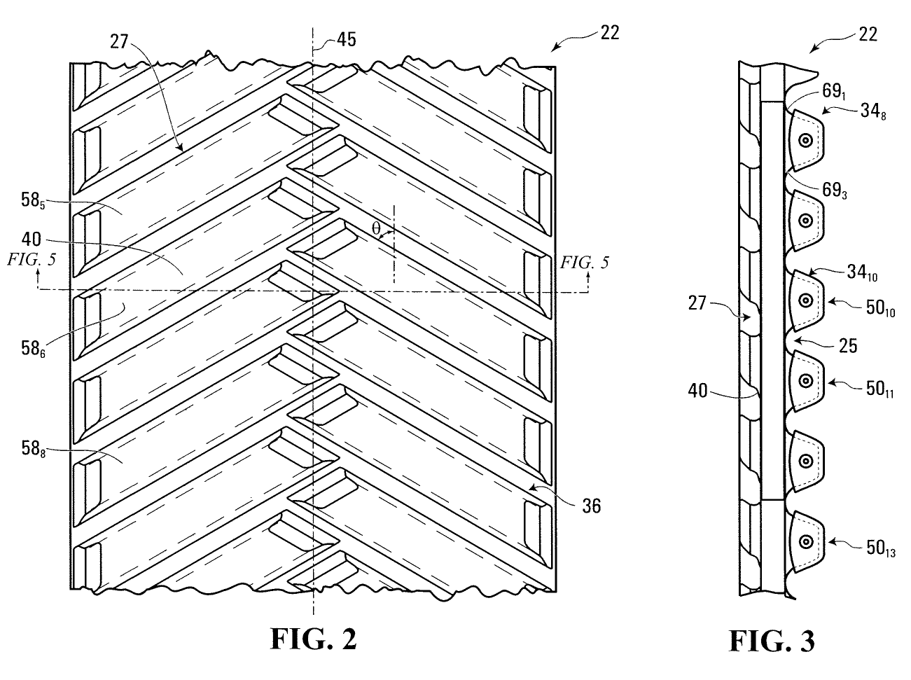

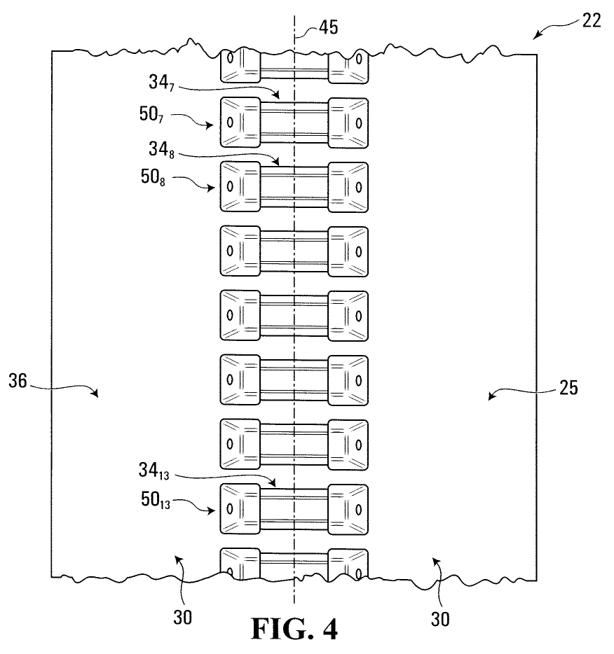

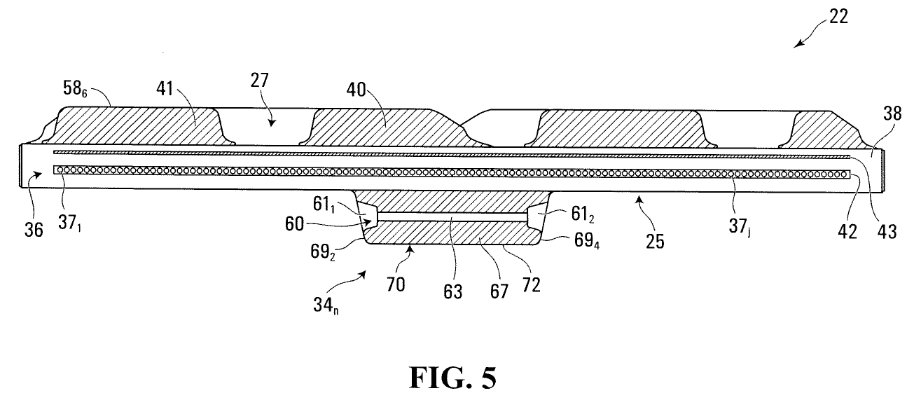

The endless track 22 provides traction to the construction vehicle 10. With additional reference to FIGS. 2 to 5, the endless track 22 comprises an inner side 25 and a ground-engaging outer side 27. The inner side 25 faces the wheels 24, 26, 28₁-28_{R} and defines an inner area in which these wheels rotate. The ground-engaging outer side 27 engages the ground for traction of the construction vehicle 10. The endless track 22 has a longitudinal axis 45 defining a longitudinal direction of the endless track 22 (i.e., a direction generally parallel to the longitudinal axis 45) and transversal directions of the endless track 22 (i.e., directions transverse to the longitudinal axis 45), including a lateral direction of the endless track 22 (i.e., a widthwise direction generally perpendicular to the longitudinal axis 45).

The endless track 22 comprises a main body 36 underlying the inner side 25 and the ground-engaging outer side 27. In view of its underlying nature, the main body 36 can be referred to as a “carcass”. In this embodiment, the carcass 36 comprises elastomeric material 38 in which are embedded a plurality of reinforcements 42, 43.

The elastomeric material 38 allows the carcass 36 to elastically change in shape as the endless track 22 is in motion around the wheels 24, 26, 28₁-28_{R}. The elastomeric material 38 can be any polymeric material with the property of elasticity. In this embodiment, the elastomeric material 38 includes rubber. Various rubber compounds may be used and, in some cases, different rubber compounds may be present in different areas of the carcass 36. In other embodiments, the elastomeric material 38 may include another elastomer in addition to or instead of rubber (e.g., polyurethane elastomer).

The reinforcement 42 comprises a plurality of reinforcing cables 37₁-37_{M} adjacent to one another. The reinforcing cables 37₁-37_{M} extend generally in the longitudinal direction of the endless track 22 to enhance strength in tension of the track 22 along its longitudinal direction. In this embodiment, each of the reinforcing cables 37₁-37_{M} is a cord or wire rope including a plurality of strands or wires. In other embodiments, each of the reinforcing cables 37₁-37_{M} may be another type of cable and may be made of any material suitably flexible longitudinally (e.g., fibers or wires of metal, plastic or composite material).

The reinforcement 43 may comprise a layer of reinforcing cables or a layer of reinforcing fabric. The reinforcing cables may be cords or wire ropes including a plurality of strands or wires (e.g., of metal, plastic or composite material). Reinforcing fabric comprises pliable material made usually by weaving, felting, or knitting natural or synthetic fibers. For example, a layer of reinforcing fabric may comprise a ply of reinforcing woven fibers (e.g., nylon fibers or other synthetic fibers). Various other types of reinforcements may be provided in the carcass 36 in other embodiments.

The ground-engaging outer side 27 comprises a tread pattern 40 to enhance traction on the ground. The tread pattern 40 comprises a plurality of traction projections 58₁-58_{T} distributed on the ground-engaging outer side 27 for enhancing traction on the ground. In this embodiment, each of the traction projections 58₁-58_{T} has an elongated shape and is angled (i.e., defines an acute angle θ) relative to the longitudinal direction of the endless track 22. The traction projections 58₁-58_{T} may have various other shapes in other examples (e.g., curved shapes, shapes with straight parts and curved parts, etc.).

In this embodiment, each of the traction projections 58₁-58_{T} comprises elastomeric material 41. The elastomeric material 41 can be any polymeric material with the property of elasticity. More particularly, in this embodiment, the elastomeric material 41 includes rubber. Various rubber compounds may be used and, in some cases, different rubber compounds may be present in different areas of each of the traction projections 58₁-58_{T}. In other embodiments, the elastomeric material 41 may include another elastomer in addition to or instead of rubber (e.g., polyurethane elastomer).

The inner side 25 of the endless track 22 contacts the drive wheel 24 in order to cause motion of the endless track 22 around the wheels 24, 26, 28₁-28_{R}. The inner side 25 also contacts the idler wheel 26 and the roller wheels 28₁-28_{R} which help to guide the endless track 22 and maintain it under tension as it is driven by the drive wheel 24.

The inner side 25 comprises a plurality of track-directing projections 34₁-34_{N} that are spaced apart in the longitudinal direction of the endless track 22. Each of the track-directing projections 34₁-34_{N}, which can be referred to as a “lug”, is used for at least one of guiding the endless track 22 and driving the endless track 22 around the wheels 24, 26, 28₁-28_{R}. In that sense, the track-directing projections 34₁-34_{N} can be referred to as “guide/drive projections”.

More particularly, in this embodiment, the track-directing projections 34₁-34_{N} are guide projections for guiding the endless track 22 around the wheels 24, 26, 28₁-28_{R} as the endless track 22 is driven by the drive wheel 24. The guide projections 34₁-34_{N}, which will be referred to as “guide lugs”, cooperate with the wheels 24, 26, 28₁-28_{R} to guide the endless track 22 as it moves around these wheels without themselves being responsible for imparting motion to the endless track 22.

The inner side 25 comprises a friction drive surface 30 that frictionally engages the drive wheel 24 such that, as the drive wheel 24 rotates, friction between the friction drive surface 30 and the drive wheel 24 causes motion of the endless track 22 around the wheels 24, 26, 28₁-28_{R} to propel the construction vehicle 10 on the ground. The endless track 22 is tensioned around the wheels 24, 26, 28₁-28_{R} to create sufficient friction between the friction drive surface 30 and the drive wheel 24 to drive the track 22.

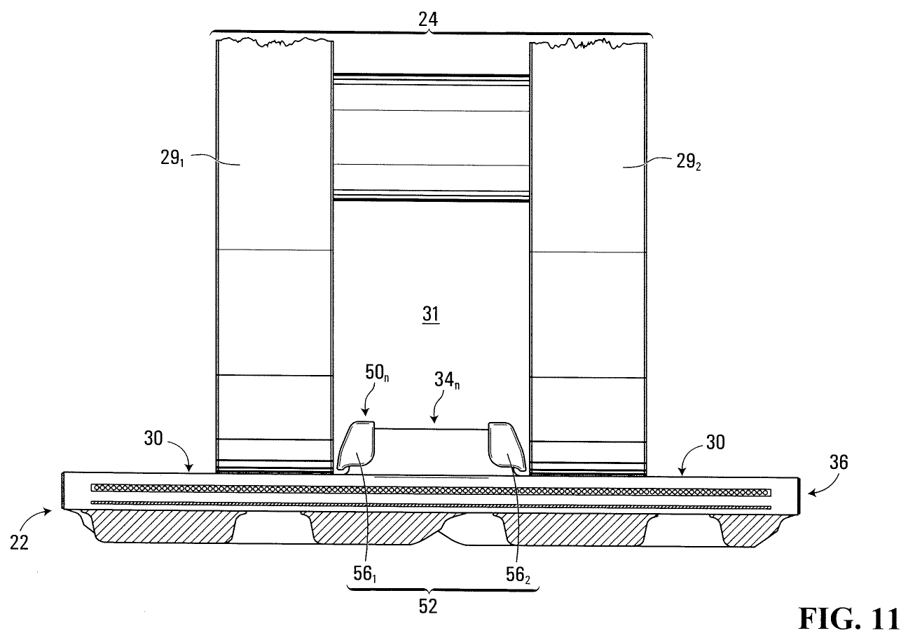

For example, as shown in FIG. 11, in this embodiment, the drive wheel 24 comprises a first wheel portion 29₁ and a second wheel portion 29₂ that are spaced apart in the lateral direction of the endless track 22 to define a space 31 therebetween. In this case, the wheel portions 29₁, 29₂ are two (2) wheel members that are separate from one another and noncontiguous. In other cases, the wheel portions 29₁, 29₂ may be contiguous. As the endless track 22 is driven by the drive wheel 24 via friction between its friction drive surface 30 and the wheel portions 29₁, 29₂, the guide lugs 34₁-34_{N} pass in the space 31 between the wheel portions 29₁, 29₂. By being constrained to move in the space 31, the guide lugs 34₁-34_{N} help to guide the motion of the endless track 22 around the wheels 24, 26, 28₁-28_{R} in order to prevent undesired lateral movement or detracking of the track 22. The guide lugs 34₁-34_{N} may interact in a similar way with other ones of the wheels 26, 28₁-28_{R} as they pass by them.

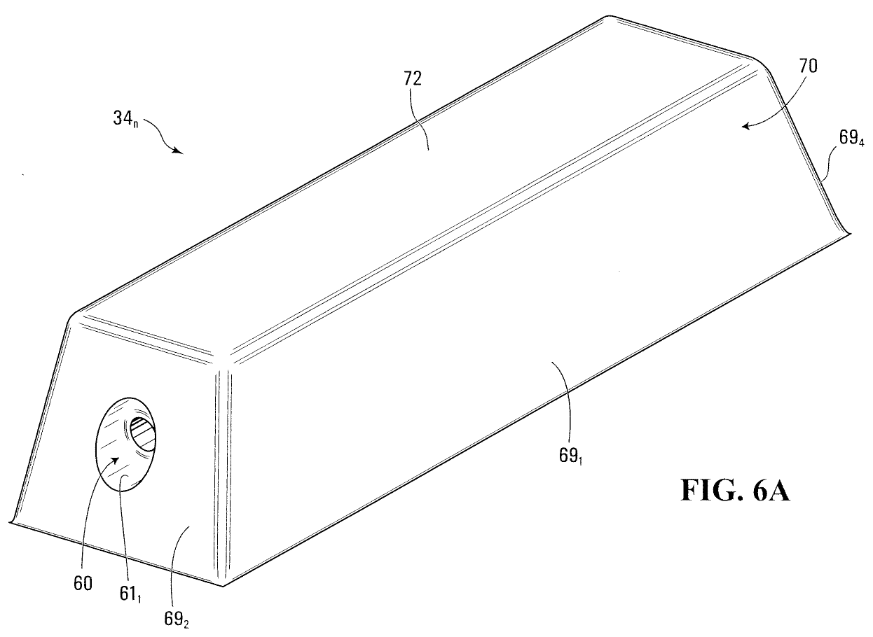

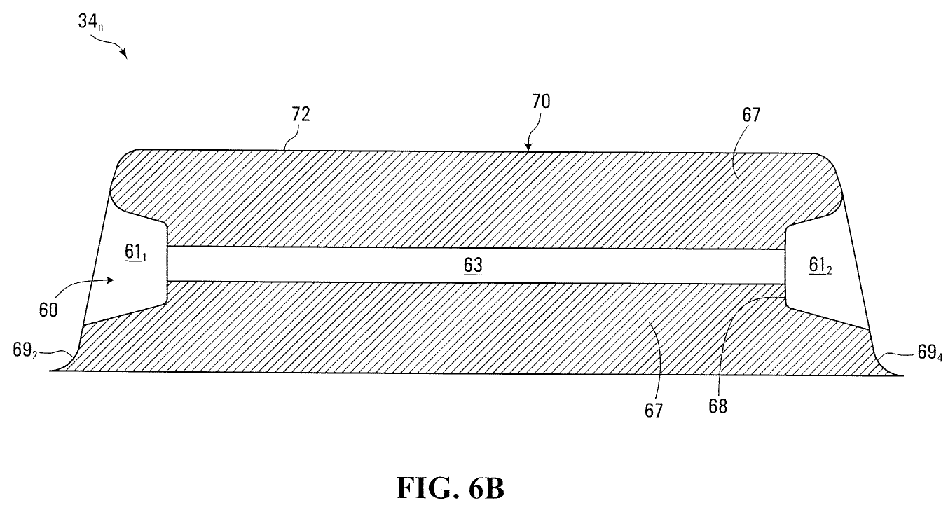

Each guide lug 34ₙ (1≦n≦N) has a periphery 70. With additional reference to FIGS. 6A and 6B, in this embodiment, the periphery 70 includes a top surface 72 and four (4) surfaces that extend downwardly from the top surface 72, namely a front surface 69₁, a rear surface 69₃ and side surfaces 69₂, 69₄ opposite one another. The guide lugs 34₁-34_{N} may have various other shapes in other embodiments.

Each guide lug 34ₙ comprises elastomeric material 67. The elastomeric material 67 can be any polymeric material with the property of elasticity. More particularly, in this embodiment, the elastomeric material 67 includes rubber. Various rubber compounds may be used and, in some cases, different rubber compounds may be present in different areas of the guide lug 34ₙ. In other embodiments, the elastomeric material 67 may include another elastomer in addition to or instead of rubber (e.g., polyurethane elastomer).

The guide lugs 34₁-34_{N} are provided with wear protectors 50₁-50_{N} for protecting them against wear due to their motion relative to the wheels 24, 26, 28₁-28_{R}. Without the wear protectors 50₁-50_{N}, as the guide lugs 34₁-34_{N} move relative to the wheels 24, 26, 28₁-28_{R}, the guide lugs 34₁-34_{N} could come into contact with one or more of the wheels 24, 26, 28₁-28_{R} and this contact could wear out their rubber 67. For instance, as each guide lug 34ₙ would pass in the space 31 between the wheel portions 29₁, 29₂ of the drive wheel 24, one or both of the side surfaces 69₂, 69₄ of the guide lug 34ₙ could rub against or otherwise frictionally contact inner surfaces of the wheel portions 29₁, 29₂. This frictional contact could be particularly strong when the construction vehicle 10 is turning or moving on a hill or other sloped terrain. Over time, such frictional contact would wear out the rubber 67 of each of the guide lugs 34₁-34_{N}, possibly to a point where the guide lugs 34₁-34_{N} are so degraded that the endless track 22 could no longer be used efficiently and would have to be repaired or replaced. In some cases, such degradation of the guide lugs 34₁-34_{N} could occur although the carcass 36 of the endless track 22 remains in acceptable condition. In other words, the guide lugs 34₁-34_{N} could wear out at a significantly greater rate than the carcass 36 of the endless track 22. However, by virtue of the wear protectors 50₁-50_{N}, such undesirable wear of the guide lugs 34₁-34_{N} can be significantly reduced if not prevented altogether.

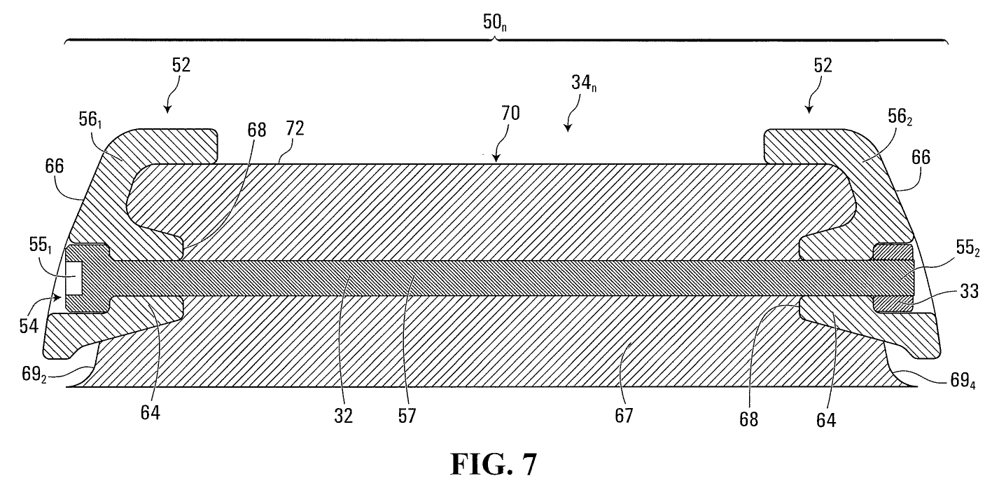

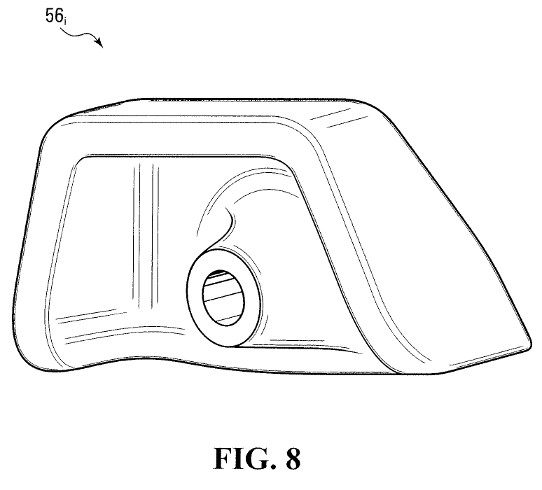

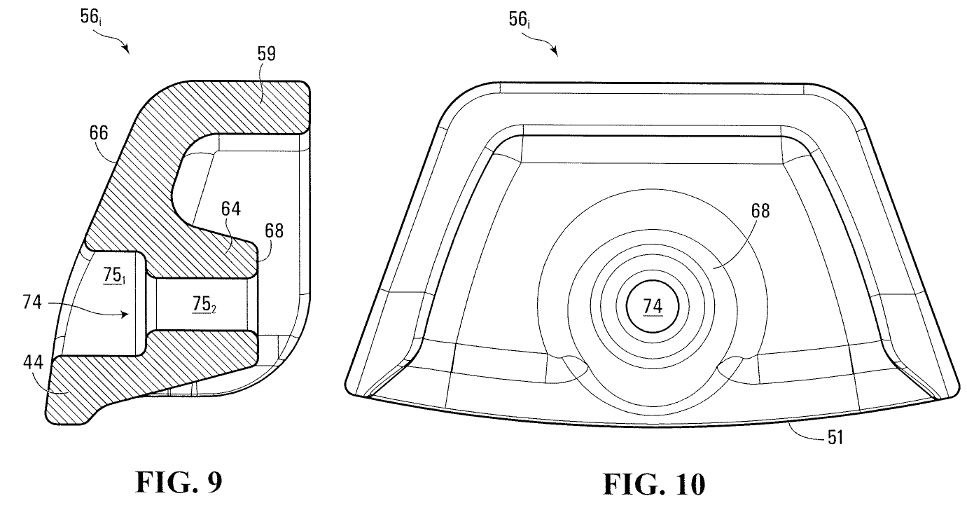

With additional reference to FIGS. 7 to 10, in this embodiment, each wear protector 50ₙ (1≦n≦N) comprises a cover 52 mountable on the periphery 70 of the guide lug 34ₙ and a fastener 54 for fastening the cover 52 to the guide lug 34ₙ. The guide lug 34ₙ comprises a cavity 60 used in connection with the wear protector 50ₙ. In this case, the cavity 60 extends through the guide lug 34ₙ from the side surface 69₂ to the side surface 69₄. The cavity 60 may be created when the guide lug 34ₙ is molded or thereafter (e.g., by drilling).

The cover 52 is shaped to cover at least part of the periphery 70 of the guide lug 34ₙ. More particularly, in this embodiment, the cover 52 comprises a first covering portion 56₁ for covering at least part of the side surface 69₂ of the guide lug 34ₙ and a second covering portion 56₂ for covering at least part of the side surface 69₄ of the guide lug 34ₙ. In this case, the first covering portion 56₁ and the second covering portion 56₂ are two (2) covering members that are separate from one another and noncontiguous. This allows protection of the side surfaces 69₂, 69₄ of the guide lug 34ₙ while minimizing a weight of the cover 52.

The covering member 56₁ covers the side surface 69₂ of the guide lug 34ₙ such that it is interposed between the side surface 69₂ and the wheels 24, 26, 28₁-28_{R}. In this way, as the guide lug 34ₙ moves relative to the wheels 24, 26, 28₁-28_{R}, the covering member 56₁ may come into contact with these wheels and thus preclude contact between the side surface 69₂ of the guide lug 34ₙ and these wheels. In turn, this reduces wearing of the rubber 67 of the guide lug 34ₙ.

Various materials may be used for the covering member 56₁. For example, in some embodiments, the covering member 56₁ may comprise material having an abrasion resistance greater than that of the rubber 67 of the guide lug 34ₙ. The material of the covering member 56₁ may also have other desirable properties, such as a low coefficient of friction with the wheels 24, 26, 28₁-28_{R}. For instance, in some cases, the covering member 56₁ may comprise rigid polymeric material (e.g., ultra-high molecular weight polyethylene (UHMWPE)), metallic material, or composite material.

The covering member 56₁ may be designed to resist forces exerted on it to restrain its movement relative to the guide lug 34ₙ when it comes into contact with one of more of the wheels 24, 26, 28₁-28_{R} as the track 22 is in motion.

For example, in this embodiment, the covering member 56₁ overlaps part of the top surface 72, the front surface 69₁, and the rear surface 69₃ of the guide lug 34ₙ. Thus, the covering member 56₁ is essentially “saddled” on the guide lug 34ₙ. In other cases, the covering member 56₁ may overlap part of only one or two of the top surface 72, the front surface 69₁, and the rear surface 69₃ of the guide lug 34ₙ.

Also, in this embodiment, the covering member 56₁ comprises a protrusion 64 that projects away from an external surface 66 of the covering member 56₁ and is positioned within the cavity 60 of the guide lug 34ₙ to help retain the covering member 56₁ in place on the guide lug 34ₙ. The protrusion 64 can restrain movement of the covering member 56₁ relative to the guide lug 34ₙ in each of two or more directions. For example, in this case, the protrusion 64 can restrain movement of the covering member 56₁ relative to the guide lug 34ₙ in a thickness direction of the endless track 22 (i.e., a generally vertical direction normal to both the longitudinal direction and the lateral direction of the endless track 22) and in various transversal directions of the endless track 22, including its lateral direction.

The protrusion 64 may be shaped in various ways in various embodiments. For instance, in this embodiment, the protrusion 64 has a shape complementary to a shape of the cavity 60 of the guide lug 34ₙ. More particularly, in this embodiment, the cavity 60 comprises a first tapering cavity portion 61₁ at a first end of the cavity 60, a second tapering cavity portion 61₂ at a second end of the cavity 60, and an intermediate cavity portion 63 between the tapering cavity portions 61₁, 61₂. The protrusion 64 is positioned in the tapering cavity portion 61₁ and has a tapering shape complementary to the tapering cavity portion 61₁. In this case, the protrusion 64 and the tapering cavity portion 61₁ have complementary generally truncated conical shapes.

The covering member 56₁ comprises an aperture 74 for admitting the fastener 54 fastening the cover 52 to the guide lug 34ₙ. More particularly, in this embodiment, the aperture 74 extends from the external surface 66 to an internal surface 68 of the covering member 56₁ through the protrusion 64. The aperture 74 comprises a first aperture portion 75₁ extending inwardly from the external surface 66 and a second aperture portion 75₂ extending from the first aperture portion 75₁ to the internal surface 68. The first aperture portion 75₁ is larger in cross-section than the second aperture portion 75₂ in order to accommodate an end portion of the fastener 54 such that this end portion does not extend beyond the external surface 66 when the fastener 54 fastens the cover 52 to the guide lug 34ₙ. For instance, as in this example, the first aperture portion 75₁ may be a counterbore or countersink.

In this embodiment, the covering member 56₁ is shaped to prevent it from interfering or at least reduce any interference with the carcass 36 as the carcass 36 bends around the wheels 24, 26, 28₁-28_{R}. More particularly, in this embodiment, the covering member 56₁ has a curved bottom edge 51 allowing the carcass 36 to bend around the wheels 24, 26, 28₁-28_{R} without engaging the covering member 56₁. Also, in this case, the covering member 56₁ has a bottom part 44 that thins down towards the bottom edge 51 to allow a more gradual load distribution at a base of the guide lug 34ₙ, thereby reducing the potential for cracks to develop at the base of the guide lug 34ₙ where most stress concentrations take place (e.g., over time, the base of the guide lug 34ₙ may slightly deform under load and acquire a shape conforming to a bottom part of the covering member 56₁).

The covering member 56₂ is configured similarly to the covering member 56₁ and covers the side surface 69₄ of the guide lug 34ₙ such that it is interposed between the side surface 69₄ and the wheels 24, 26, 28₁-28_{R}.

The fastener 54 may comprise any device or group of devices capable of being used to fasten the cover 52 to the guide lug 34ₙ. For example, in various embodiments, the fastener 54 may comprise one or more of a threaded fastener (e.g., a bolt or stud with a nut, a screw, etc.), a cable (e.g., a cord or wire rope including a plurality of strands or wires, etc.), or any other hardware capable of being used to fasten the cover 52 to the guide lug 34ₙ.

In this embodiment, the fastener 54 fastens the cover 52 to the guide lug 34ₙ such that the fastener 54 extends inside the guide lug 34ₙ and is capable of being put in a state of tension. For example, in this embodiment, the fastener 54 comprises a first retaining portion 55₁ and a second retaining portion 55₂ spaced apart from one another and an elongated portion 57 extending between the retaining portions 55₁, 55₂ inside the guide lug 34ₙ. The retaining portions 55₁, 55₂ are positionable (e.g., by a tightening action) relative to one another such that the elongated portion 57 is put under tension. This state of tension of the fastener 54 may enhance retention of the cover 52 on the guide lug 34ₙ (e.g., by allowing some preload). Also, this state of tension may allow the cover 52 to compress part of the rubber 67 of the guide lug 34ₙ. Such a state of compression of the rubber 67 may increase its durability. For instance, this state of compression may be such that, in use, the rubber 67 of the guide lug 34ₙ does not experience a stress cycle that alternates between tensile and compressive stresses, but rather remains in the compression stress domain. This can hinder crack propagation and thus enhance a fatigue resistance of the rubber 67 of the guide lug 34ₙ. Putting the fastener 54 under tension may thus enhance the efficiency of the wear protector 50ₙ in protecting the guide lug 34ₙ. While the fastener 54 is capable of being put in a state of tension, it may be decided in some cases to not put the fastener 54 in such a state of tension.

More particularly, in this embodiment, the fastener 54 fastens the covering members 56₁, 56₂ to the guide lug 34ₙ by extending inside the guide lug 34ₙ and interconnecting the covering members 56₁, 56₂. The fastener 54 comprises a bolt 32 and an internally threaded element 33 (e.g., a nut or threaded insert) to which the bolt 32 is secured. Thus, in this case, a head of the bolt 32 and the internally threaded element 33 constitute the retaining portions 55₁, 55₂ of the fastener 54, while a shank of the bolt 32 constitutes the elongated portion 57 of the fastener 54.

When the wear protector 50ₙ is installed on the guide lug 34ₙ, each of the covering members 56₁, 56₂ is placed on the guide lug 34ₙ such that it covers one of the side surfaces 69₂, 69₄ of the guide lug 34ₙ, overlaps part of the top surface 72, the front surface 69₁, and the rear surface 69₃ of the guide lug 34ₙ, and has its protrusion 64 positioned within the cavity 60 of the guide lug 34ₙ. The bolt 32 is inserted through the aperture 74 of each of the covering members 56₁, 56₂ and is secured in place by being screwed into the internally threaded element 33. The head of the bolt 32 is positioned in the counterbore 75₁ of the covering member 56₁ and the internally threaded element 33 is positioned in the counterbore 75₁ of the covering member 56₂, thereby preventing the head of the bolt 32 and the internally threaded element 33 from projecting beyond the external surface 66 of each of these covering members and contacting one or more of the wheels 24, 26, 28₁-28_{R}. The bolt 32 may be placed in a state of tension by further screwing it into the internally threaded element 33. This may be continued to increase pressure applied by the covering members 56₁, 56₂ on the rubber 67 of the guide lug 34ₙ so as to put at least part of the rubber 67 in a state of compression.

The wear protectors 50₁-50_{N} thus provide an efficient way of protecting the guide lugs 34₁-34_{N} against wear due to their motion relative to the wheels 24, 26, 28₁-28_{R}.

The wear protectors 50₁-50_{N} may be configured in various other ways in other embodiments.

For example, in other embodiments, the cover 52 of the wear protector 50ₙ may have various other shapes to protect different portions of the periphery 70 of the guide lug 34ₙ. In particular, in other embodiments, the cover 52 may cover a greater part (including all) or a lesser part of the periphery 70 of the guide lug 34ₙ. For instance, in some cases, the cover 52 may cover the top surface 72, front surface 69₁, rear surface 69₃ and side surfaces 69₂, 69₄ of the guide lug 34ₙ.

As another example, in some embodiments, instead of extending between the side surfaces 69₂, 69₄ of the guide lug 34ₙ, the cavity 60 of the guide lug 34ₙ may extend from the front surface 69₁ to the rear surface 69₃ of the guide lug 34ₙ, in which case the cover 52 may comprise covering portions (similar to the covering portions 56₁, 56₂) that cover at least part of these front and rear surfaces of the guide lug 34ₙ and that have protrusions (similar to the protrusion 64 of each of the covering portions 56₁, 56₂) positionable within the cavity 60 to help retain the cover 52 in place on the guide lug 34ₙ.

As another example, instead of constituting two separate and noncontiguous covering members 56₁, 56₂, in some embodiments, the first covering portion 56₁ and the second covering portion 56₂ may be part of a one-piece covering member. For instance, in some cases, the one-piece covering member may cover the top surface 72, front surface 69₁, rear surface 69₃ and side surfaces 69₂, 69₄ of the guide lug 34ₙ.

As yet another example, the fastener 54 may comprise any other device or group of devices capable of being used to fasten the cover 52 to the guide lug 34ₙ. For instance, in some embodiments, the fastener 54 may comprise a cable and a pair of fittings (e.g., rings) mounted to the cable, in which case the fittings constitute the retaining portions 55₁, 55₂ of the fastener 54 and the cable constitutes the elongated portion 57 of the fastener 54. As yet another example, the wear protector 50ₙ may comprise more than one fastener such as the fastener 54 to fasten the cover 52 to the guide lug 34ₙ.

As yet another example, in some embodiments, the wear protectors 50₁-50_{N} may be designed to prevent one or more of the wheels 24, 26, 28₁-28_{R} from jumping on top of the guide lugs 34₁-34_{N} (e.g., due to terrain irregularities and/or motion of the construction vehicle 10). For instance, a top part 59 of the cover 52 may extend by a certain distance above the top surface 72 of the guide lug 34ₙ to prevent one or more of these wheels from jumping on top of the guide lug 34ₙ.

Although in this embodiment the track-directing projections 34₁-34_{N} are guide lugs, in other embodiments, the track-directing projections 34₁-34_{N} may be drive projections, referred to as “drive lugs”, which interact with the drive wheel 24 in order to move the endless track 22 around the wheels 24, 26, 28₁-28_{R} and which are protected against wear by wear protectors such as the wear protectors 50₁-50_{N}. For instance, in such embodiments, the drive wheel 24 may comprise a drive sprocket including teeth or bars and the drive lugs 34₁-34_{N} interact with the teeth or bars of the drive wheel 24 in order to cause the endless track 22 to move around the wheels 24, 26, 28₁-28_{R}. The drive lugs 34₁-34_{N} may also serve to guide the endless track 22 as it is driven around the wheels 24, 26, 28₁-28_{R}.

While in this embodiment the endless track 22 is a one-piece jointless track, in other embodiments, the endless track 22 may be a “segmented” track comprising a plurality of track sections connected to one another at a plurality of joints. In yet other embodiments, the endless track 22 may be a one-piece track that can be closed like a belt with connectors at both of its longitudinal ends to form a joint.

The track assembly 16; may be configured in various other ways in other embodiments. For example, in some embodiments, the track assembly 16; may comprise a front drive wheel (e.g., the idler wheel 26 may be replaced by a drive wheel) instead of or in addition to the drive wheel 24. As another example, in some embodiments, the track assembly 16; may comprise more or less roller wheels such as the roller wheels 28₁-28_{R}. As yet another example, rather than have a generally oblong configuration as in this embodiment, in other embodiments, the track assembly 16; may have various other configurations (e.g., a generally triangular configuration).

While in embodiments considered above the off-road vehicle 10 is a construction vehicle for performing construction work, in other embodiments, the off-road vehicle 10 may be an agricultural vehicle (e.g., a harvester, a combine, a tractor, etc.) for performing agricultural work, a forestry vehicle (e.g., a feller-buncher, a tree chipper, a knuckleboom loader, etc.) for performing forestry work, a military vehicle (e.g., a combat engineering vehicle (CEV), etc.) for performing work in a military application, a transporter vehicle (e.g., a heavy hauler, a flatbed truck, a trailer, a carrier, etc.) for transporting equipment, materials, cargo or other objects, or any other vehicle operable off paved roads. Although operable off paved roads, an off-road vehicle may also be operable on paved roads in some cases. Also, while in embodiments considered above the off-road vehicle 10 is driven by a human operator in the vehicle 10, in other embodiments, the off-road vehicle 10 may be an unmanned ground vehicle (e.g., a teleoperated or autonomous unmanned ground vehicle).

Although various embodiments and examples have been presented, this was for the purpose of describing, but not limiting, the invention. Various modifications and enhancements will become apparent to those of ordinary skill in the art and are within the scope of the invention, which is defined by the appended claims.

1. A cover for protecting a lug of an inner side of an endless track for traction of an off-road vehicle, the lug comprising elastomeric material and being used for at least one of guiding the endless track and driving the endless track, the cover being shaped to cover at least part of a periphery of the lug, the cover comprising an aperture for admitting a fastener to fasten the cover to the lug such that the fastener extends inside the lug and is capable of being put in a state of tension.

2. A cover as claimed in claim 1, wherein the cover compresses the lug when the fastener is in the state of tension.

3. A cover as claimed in claim 1, wherein the fastener comprises a first retaining portion, a second retaining portion spaced apart from the first retaining portion, and an elongated portion extending between the first retaining portion and the second retaining portion inside the lug, the aperture allowing the first retaining portion and the second retaining portion to be positioned relative to one another such that the elongated portion is put in the state of tension.

4. A cover as claimed in claim 1, wherein the periphery of the lug comprises a first surface and a second surface opposite the first surface, the cover comprising a first covering portion for covering at least part of the first surface of the lug and a second covering portion for covering at least part of the second surface of the lug, the aperture being located in the first covering portion.

5. A cover as claimed in claim 4, wherein the aperture is a first aperture, the second covering portion comprising a second aperture coaxial with the first aperture when the cover is fastened to the lug.

6. A cover as claimed in claim 4, wherein the first covering portion is a first covering member and the second covering portion is a second covering member separate from the first covering member.

7. A cover as claimed in claim 6, wherein the fastener extends through the lug and interconnects the first covering member and the second covering member when the cover is fastened to the lug.

8. A cover as claimed in claim 6, wherein the first surface is a first side surface and the second surface is a second side surface, the periphery of the lug comprising a top surface, a front surface and a rear surface, each of the first covering member and the second covering member overlapping part of at least one of the top surface, the front surface and the rear surface of the lug.

9. A cover as claimed in claim 6, wherein the first surface is a first side surface and the second surface is a second side surface, the periphery of the lug comprising a top surface, a front surface and a rear surface, each of the first covering member and the second covering member overlapping part of each of the top surface, the front surface and the rear surface of the lug.

10. A cover as claimed in claim 1, wherein the aperture comprises a first aperture portion extending inwardly from an external surface of the cover and a second aperture portion extending from the first aperture portion to an internal surface of the cover, the first aperture portion being larger in cross-section than the second aperture portion to accommodate a portion of the fastener that is larger than another portion of the fastener.

11. A cover as claimed in claim 1, wherein the lug comprises a cavity, the cover comprising a protrusion positionable within the cavity to retain the cover on the lug.

12. A cover as claimed in claim 11, wherein the protrusion restrains movement of the cover relative to the lug in two or more directions.

13. A cover as claimed in claim 11, wherein the aperture extends in the protrusion.

14. A cover as claimed in claim 11, wherein the protrusion has a shape complementary to a shape of the cavity.

15. A cover as claimed in claim 11, wherein the protrusion is a tapering protrusion.

16. A cover as claimed in claim 15, wherein the protrusion has a truncated conical shape.

17. A cover as claimed in claim 4, wherein each of the first covering portion and the second covering portion has a curved bottom edge.

18. A cover as claimed in claim 1, wherein the cover comprises at least one of rigid polymeric material, metallic material, and composite material.

19. A cover as claimed in claim 1, wherein the fastener comprises a threaded fastener.

20. A cover as claimed in claim 1, wherein the fastener comprises a cable.

21. A cover as claimed in claim 1, wherein the elastomeric material includes rubber.

22. A cover as claimed in claim 1, wherein the off-road vehicle is one of a construction vehicle, an agricultural vehicle, a forestry vehicle, a military vehicle, and a transporter vehicle.

23. A wear protector comprising a cover as claimed in claim 1 and the fastener to fasten the cover to the lug.

24. An endless track for traction of an off-road vehicle, the endless track comprising:
a ground-engaging outer side for engaging the ground;
an inner side for facing a plurality of wheels of the off-road vehicle, the inner side comprising a plurality of lugs for at least one of guiding the endless track and driving the endless track, each lug comprising:
elastomeric material;
a periphery on which is placeable a cover for protecting the lug; and
a cavity for admitting a fastener to fasten the cover to the lug.

25. A cover for protecting a lug of an inner side of an endless track for traction of an off-road vehicle, the lug comprising elastomeric material, a periphery, and a cavity extending inwardly from the periphery, the cover being shaped to cover at least part of the periphery of the lug and comprising:
a protrusion positionable within the cavity to retain the cover on the lug; and
an aperture for admitting a fastener to fasten the cover to the lug.

26. An endless track for traction of an off-road vehicle, the endless track comprising:
a ground-engaging outer side for engaging the ground;
an inner side for facing a plurality of wheels of the off-road vehicle, the inner side comprising a plurality of lugs for at least one of guiding the endless track and driving the endless track, each lug comprising:
elastomeric material;
a periphery on which is placeable a cover for protecting the lug, the cover comprising a protrusion; and
a cavity for receiving the protrusion and admitting a fastener to fasten the cover to the lug.

27. A cover for protecting a lug of an inner side of an endless track for traction of an off-road vehicle, the lug comprising elastomeric material, a periphery, and a cavity extending inwardly from the periphery, the cover being shaped to cover at least part of the periphery of the lug, the cover comprising a protrusion positionable within the cavity to retain the cover on the lug, the protrusion being configured to restrain movement of the cover relative to the lug in two or more directions.

28. An endless track for traction of an off-road vehicle, the endless track comprising:
a ground-engaging outer side for engaging the ground;
an inner side for facing a plurality of wheels of the off-road vehicle, the inner side comprising a plurality of lugs for at least one of guiding the endless track and driving the endless track, each lug comprising:
elastomeric material;
a periphery on which is placeable a cover for protecting the lug, the cover comprising a protrusion; and
a cavity for receiving the protrusion, the protrusion restraining movement of the cover relative to the lug in two or more directions when the protrusion is in the cavity.

29. A cover for protecting a lug of an inner side of an endless track for traction of an off-road vehicle, the lug comprising elastomeric material and having a periphery, the periphery of the lug comprising a first surface and a second surface opposite the first surface, the cover comprising:
a first covering member for covering at least part of the first surface of the lug; and
a second covering member, separate from the first covering member, for covering at least part of the second surface of the lug.

30. An endless track for traction of an off-road vehicle, the endless track comprising:
a ground-engaging outer side for engaging the ground;
an inner side for facing a plurality of wheels of the off-road vehicle, the inner side comprising a plurality of lugs for at least one of guiding the endless track and driving the endless track, each lug comprising:
elastomeric material;
a periphery comprising a first surface and a second surface opposite the first surface, at least part of the first surface being coverable by a first covering member, at least part of the second surface being coverable by a second covering member separate from the first covering member; and
a cavity extending from the first surface to the second surface for admitting a fastener interconnecting the first covering member and the second covering member.
